(19) United States
(12) Patent Application Publication
(10) Pub. No.: US 2023/0140324 A1
(43) Pub. Date: May 4, 2023

(54) METHOD OF CREATING 3D VOLUMETRIC SCENE

(71) Applicant: GM Global Technology Operations LLC, Detroit, MI (US)

(72) Inventors: Christina Shin, Los Angeles, CA (US); Chuan Li, Troy, MI (US); Fan Bai, Ann Arbor, MI (US); Ramesh Govindan, Cerritos, CA (US)

(21) Appl. No.: 17/515,955

(22) Filed: Nov. 1, 2021

(51) Int. Cl. H04N 19/597; B60R 1/00; H04N 19/96; H04N 19/60

(52) U.S. Cl. CPC H04N 19/597; B60R 1/00; H04N 19/96; H04N 19/60; B60R 2300/304

(57) ABSTRACT

A system for creating a 3D volumetric scene includes a first visual sensor positioned onboard a first vehicle to obtain first visual images, first motion sensors positioned onboard the first vehicle to obtain first motion data, a first computer processor positioned onboard the first vehicle and adapted to generate a first scene point cloud, a second visual sensor positioned onboard a second vehicle to obtain second visual images, second motion sensors positioned onboard the second vehicle to obtain second motion data, and a second computer processor positioned onboard the second vehicle and adapted to generate a second scene point cloud, the first and second computer processors further adapted to send the first and second scene point clouds to a third computer processor, and the third computer processor located within an edge/cloud infrastructure and adapted to create a stitched point cloud.

### INTRODUCTION

The present disclosure relates to a method and system of creating a 3D volumetric point cloud of a traffic scene by merging 3D volumetric point clouds from multiple vehicles.

Automotive vehicles use motion sensors and visions sensors to capture images of their surroundings and create 3D volumetric point cloud representations of a vehicle's surroundings and the vehicle's position therein. Such 3D volumetric point clouds are limited due to the single point of view provided by the vehicle. In addition, objects in the field of view of the vehicle prevent creation of a complete 3D volumetric point cloud of the vehicles surroundings. Finally, the ability of a vehicle to use onboard motion and vision sensors to “see” and create a 3D volumetric point cloud of the vehicle's surroundings is limited by the range limitations of the onboard vision sensors.

Thus, while current systems and methods achieve their intended purpose, there is a need for a new and improved system and method for creating a 3D volumetric point cloud of a traffic scene by merging multiple 3D volumetric point clouds created by multiple vehicles.

### SUMMARY

According to several aspects of the present disclosure, a method of creating a 3D volumetric scene includes obtaining first visual images from a first visual sensor onboard a first vehicle, obtaining first motion data from a first plurality of motion sensors onboard the first vehicle, generating, via a first computer processor onboard the first vehicle, a first scene point cloud, using the first visual images and the first motion data, obtaining second visual images from a second visual sensor onboard a second vehicle, obtaining second motion data from a second plurality of motion sensors onboard the second vehicle, generating, via a second computer processor onboard the second vehicle, a second scene point cloud, using the second visual images and the second motion data, sending the first scene point cloud and the second scene point cloud to a third computer processor located within an edge/cloud infrastructure, and merging, via the third computer processor, the first scene point cloud and the second scene point cloud and creating a stitched point cloud.

According to another aspect, the method further includes generating, via the first computer processor, a first raw point cloud using the first visual images, generating, via the first computer processor, a first roughly transformed point cloud by using the first motion data to transform the first raw point cloud, generating, via the second computer processor, a second raw point cloud using the second visual images, and generating, via the second computer processor, a second roughly transformed point cloud by using the second motion data to transform the second raw point cloud.

According to another aspect, the method includes generating, via the first computer processor, the first scene point cloud by using a high-definition map and applying a normal distribution transformation algorithm to the first roughly transformed point cloud, and generating, via the second computer processor, the second scene point cloud by using a high-definition map and applying a normal distribution transformation algorithm to the second roughly transformed point cloud.

According to another aspect, the generating, via the first computer processor, the first scene point cloud by using a high-definition map and applying the normal distribution transformation algorithm to the first roughly transformed point cloud further includes removing dynamic objects from the first roughly transformed point cloud prior to applying the normal distribution transformation algorithm, and the generating, via the second computer processor, the second scene point cloud by using a high-definition map and applying the normal distribution transformation algorithm to the second roughly transformed point cloud further includes removing dynamic objects from the second roughly transformed point cloud prior to applying the normal distribution transformation algorithm.

According to another aspect, the generating, via the first computer processor, the first scene point cloud by using a high-definition map and applying the normal distribution transformation algorithm to the first roughly transformed point cloud further includes re-using a resulting first transformation matrix by inserting the resulting first transformation matrix back into the normal distribution transformation algorithm to improve accuracy of the first scene point cloud, and the generating, via the second computer processor, the second scene point cloud by using a high-definition map and applying the normal distribution transformation algorithm to the second roughly transformed point cloud further includes re-using a resulting second transformation matrix by inserting the resulting second transformation matrix back into the normal distribution transformation algorithm to improve accuracy of the second scene point cloud.

According to another aspect, the method further includes generating, via the first computer processor, a first raw point cloud using the first visual images, generating, via the first computer processor, the first scene point cloud by using the first motion data to transform the first raw point cloud, generating, via the second computer processor, a second raw point cloud using the second visual images, and generating, via the second computer processor, the second scene point cloud by using the second motion data to transform the second raw point cloud.

According to another aspect, sending the first scene point cloud and the second scene point cloud to a third computer processor further includes compressing, via the first computer processor, the first scene point cloud prior to sending the first scene point cloud to the third computer processor, and de-compressing, via the third computer processor, the first scene point cloud after sending the first scene point cloud to the third computer processor, and compressing, via the second computer processor, the second scene point cloud prior to sending the second scene point cloud to the third computer processor, and de-compressing, via the third computer processor, the second scene point cloud after sending the second scene point cloud to the third computer processor.

According to another aspect, compressing/de-compressing the first scene point cloud and the second scene point cloud is by an Octree-based point cloud compression method.

According to another aspect, the method further includes identifying an overlap region between the first scene point cloud and the second scene point cloud by applying, via the third computer processor, an overlap searching algorithm to the first scene point cloud and the second scene point cloud after de-compressing the first scene point cloud and the second scene point cloud.

According to another aspect, the method further includes applying, via the third computer processor, an iterative closest point-based point cloud alignment algorithm to the overlap region between the first scene point cloud and the second scene point cloud after identifying the overlap region between the first scene point cloud and the second scene point cloud.

According to several aspects of the present disclosure, a system for creating a 3D volumetric scene includes a first visual sensor positioned onboard a first vehicle and adapted to obtain first visual images, a first plurality of motion sensors positioned onboard the first vehicle and adapted to obtain first motion data, a first computer processor positioned onboard the first vehicle and adapted to generate a first scene point cloud, using the first visual images and the first motion data, a second visual sensor positioned onboard a second vehicle and adapted to obtain second visual images, a second plurality of motion sensors positioned onboard the second vehicle and adapted to obtain second motion data, and a second computer processor positioned onboard the second vehicle and adapted to generate a second scene point cloud, using the second visual images and the second motion data, the first computer processor further adapted to send the first scene point cloud to a third computer processor and the second computer processor further adapted to send the second scene point cloud to the third computer processor, and the third computer processor located within an edge/cloud infrastructure and adapted to merge the first scene point cloud and the second scene point cloud and create a stitched point cloud.

According to another aspect, the first computer processor is further adapted to generate a first raw point cloud using the first visual images and to generate a first roughly transformed point cloud by using the first motion data to transform the first raw point cloud, and the second computer processor is further adapted to generate a second raw point cloud using the second visual images and to generate a second roughly transformed point cloud by using the second motion data to transform the second raw point cloud.

According to another aspect, the first computer processor is further adapted to generate the first scene point cloud by using a high-definition map and applying a normal distribution transformation algorithm to the first roughly transformed point cloud, and the second computer processor is further adapted to generate the second scene point cloud by using a high-definition map and applying a normal distribution transformation algorithm to the second roughly transformed point cloud.

According to another aspect, the first computer processor is further adapted to remove dynamic objects from the first roughly transformed point cloud prior to applying the normal distribution transformation algorithm, and the second computer processor is further adapted to remove dynamic objects from the second roughly transformed point cloud prior to applying the normal distribution transformation algorithm.

According to another aspect, the first computer processor is further adapted to re-use a resulting first transformation matrix by inserting the resulting first transformation matrix back into the normal distribution transformation algorithm to improve accuracy of the first scene point cloud, and the second computer processor is further adapted to re-use a resulting second transformation matrix by inserting the resulting second transformation matrix back into the normal distribution transformation algorithm to improve accuracy of the second scene point cloud.

According to another aspect, the first computer processor is further adapted to generate a first raw point cloud using the first visual images and to generate the first scene point cloud by using the first motion data to transform the first raw point cloud, and the second computer processor is adapted to generate a second raw point cloud using the second visual images and to generate the second scene point cloud by using the second motion data to transform the second raw point cloud.

According to another aspect, the first computer processor is further adapted to compress the first scene point cloud before the first scene point cloud is sent to the third computer processor, the third computer processor is adapted to de-compress the first scene point cloud after the first scene point cloud is sent to the third computer processor, the second computer processor is further adapted to compress the second scene point cloud before the second scene point cloud is sent to the third computer processor, and the third computer processor is adapted to de-compress the second scene cloud after the second scene cloud is sent to the third computer processor.

According to another aspect, the first scene point cloud and the second scene point cloud are each compressed/de-compressed by an Octree-based point cloud compression method.

According to another aspect, the third computer processor is further adapted to identify an overlap region between the first scene point cloud and the second scene point cloud by applying an overlap searching algorithm to the first scene point cloud and the second scene point cloud after the first scene point cloud and the second scene point cloud are de-compressed.

According to another aspect, the third computer processor is further adapted to apply an iterative closest point-based point cloud alignment algorithm to the overlap region between the first scene point cloud and the second scene point cloud after the overlap region between the first scene point cloud and the second scene point cloud has been identified.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a system according to an exemplary embodiment pf the present disclosure;

FIG. 2 is an illustration of a traffic intersection wherein multiple vehicles are present;

FIG. 3 is a flowchart illustrating a method according to an exemplary embodiment;

FIG. 4 is a flowchart illustrating a normal distribution transformation algorithm according to an exemplary embodiment; and

FIG. 5 is a flowchart illustrating a iterative closest point-based point cloud alignment algorithm according to an exemplary embodiment.

### DETAILED DESCRIPTION

The following description is merely exemplary in nature and is not intended to limit the present disclosure, application, or uses.

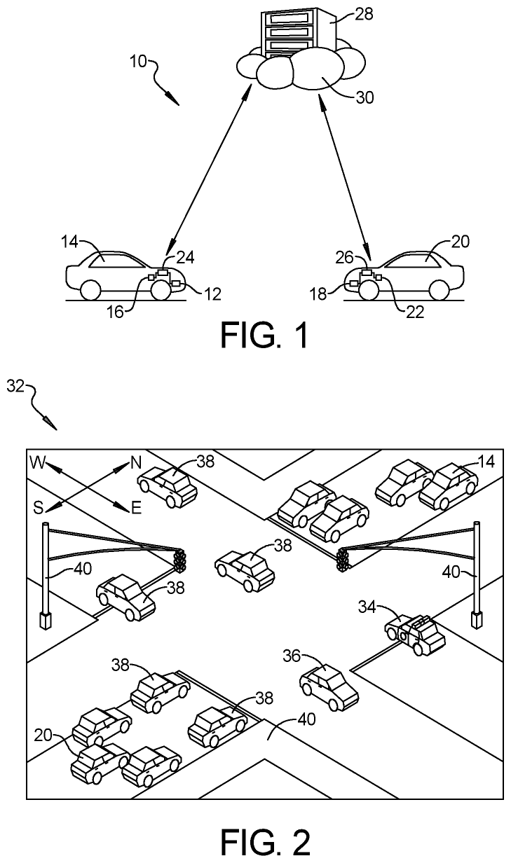

Referring to FIG. 1, a system 10 for creating a 3D volumetric scene includes a first visual sensor 12 positioned onboard a first vehicle 14 that is adapted to obtain first visual images and a first plurality of motion sensors 16 positioned onboard the first vehicle 14 that are adapted to obtain first motion data. The system 10 further includes a second visual sensor 18 positioned onboard a second vehicle 20 that is adapted to obtain second visual images and a second plurality of motion sensors 22 positioned onboard the second vehicle 20 that are adapted to obtain second motion data.

The first and second visual sensors 12, 18 may be made up of one or more different sensor types including, but not limited to, cameras, radars, and lidars. Video cameras and sensors see and interpret objects in the road just like human drivers do with their eyes. Typically, video cameras are positioned around the vehicle at every angle to maintain a 360 degree view around the vehicle and providing a broader picture of the traffic conditions around them. Video cameras display highly detailed and realistic images, and automatically detect objects, such as other cars, pedestrians, cyclists, traffic signs and signals, road markings, bridges, and guardrails, classify them, and determine the distances between them and the vehicle.

Radar (Radio Detection and Ranging) sensors send out radio waves that detect objects and gauge their distance and speed in relation to the vehicle in real time. Both short range and long range radar sensors may be used. Lidar (Light Detection and Ranging) sensors work similar to radar sensors, with the only difference being that they use lasers instead of radio waves. Apart from measuring the distances to various objects on the road, lidar allows creating 3D images of the detected objects and mapping of the surroundings. Moreover, lidar can be configured to create a full 360-degree map around the vehicle rather than relying on a narrow field of view.

The first and second plurality of motion sensors 16, 22 are adapted to provide data related to the orientation and motion of the first and second vehicles 14, 20. In an exemplary embodiment, the first and second plurality of motion sensors 16, 22 each includes an inertial measurement unit (IMU) and a global positioning system (GPS). An IMU is an electronic device that measures and reports a body's specific force, angular rate, and sometimes the orientation of the body, using a combination of accelerometers, gyroscopes, and sometimes magnetometers. IMUs have typically been used to maneuver aircraft (an attitude and heading reference system), including unmanned aerial vehicles (UAVs), among many others, and spacecraft, including satellites and lenders. Recent developments allow for the production of IMU-enabled GPS devices. An IMU allows a GPS receiver to work when GPS-signals are unavailable, such as in tunnels, inside buildings, or when electronic interference is present

In land vehicles, an IMU can be integrated into GPS based automotive navigation systems or vehicle tracking systems, giving the system a dead reckoning capability and the ability to gather as much accurate data as possible about the vehicle's current speed, turn rate, heading, inclination and acceleration. In a navigation system, the data reported by the IMU is fed into a processor which calculates attitude, velocity and position. This information can be integrated with an angular rate from the gyroscope to calculate angular position. This is fused with the gravity vector measured by the accelerometers in a Kalman filter to estimate attitude. The attitude estimate is used to transform acceleration measurements into an inertial reference frame (hence the term inertial navigation) where they are integrated once to get linear velocity, and twice to get linear position. The Kalman filter applies an algorithm that uses a series of measurements observed over time, including statistical noise and other inaccuracies, and produces estimates of unknown variables that tend to be more accurate than those based on a single measurement alone, by estimating a joint probability distribution over the variables for each timeframe.

A first computer processor 24 is positioned onboard the first vehicle 14 and is adapted to generate a first scene point cloud, using the first visual images and the first motion data. A second computer processor 26 is positioned onboard the second vehicle 20 and is adapted to generate a second scene point cloud, using the second visual images and the second motion data. The computer processors 24, 26 described herein are non-generalized, electronic control devices having a preprogrammed digital computer or processor, memory or non-transitory computer readable medium used to store data such as control logic, software applications, instructions, computer code, data, lookup tables, etc., and a transceiver or input/output ports, with capability to send/receive data over a WLAN, 4G or 5G network, or the like. Computer readable medium includes any type of medium capable of being accessed by a computer, such as read only memory (ROM), random access memory (RAM), a hard disk drive, a compact disc (CD), a digital video disc (DVD), or any other type of memory. A “nontransitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

A point cloud is a set of data points in space. The points may represent a 3D shape or object. Each point position has its set of Cartesian coordinates (X, Y, Z). Point clouds are used for many purposes, including to create 3D CAD models for manufactured parts, for metrology and quality inspection, and for a multitude of visualization, animation, rendering and mass customization applications. In automotive applications, a vehicle uses data gathered by motion and vision sensors to create a point cloud that is a 3D representation of the environment surrounding the vehicle. The 3D point cloud allows a vehicle to “see” its' environment, particularly, other vehicles within the vicinity of the vehicle, to allow the vehicle to operate and navigate safely. This is particularly important when the vehicle is an autonomous vehicle and navigation of the vehicle is entirely controlled by the vehicle's onboard systems.

The first computer processor 24 is further adapted to send the first scene point cloud to a third computer processor 28 and the second computer processor 26 is further adapted to send the second scene point cloud to the third computer processor 28. In an exemplary embodiment, the third computer processor 28 is located within an edge/cloud infrastructure 30 and is adapted to merge the first scene point cloud and the second scene point cloud and create a stitched point cloud. The stitched point cloud takes all the data from the first and second scene point clouds, aligns and merges the data to provide a more accurate 3D volumetric representation of a traffic scene.

Referring to FIG. 2, an intersection 32 is shown where the first vehicle 14 approaches the intersection from one direction, and the second vehicle 20 approaches the intersection 32 from the opposite direction. Each of the first and second vehicles 14, 20 will collect different data of the intersection 32 from the visual sensors 12, 18 and motion sensors 16, 22 positioned on the first and second vehicles 14, 20, and consequently, the first and second vehicles 14, 20 will independently create different 3D volumetric representations of the intersection 32.

For example, the first vehicle 14 approaches the intersection 32 from the north and the second vehicle 20 approaches the intersection from the south. An emergency vehicle 34 is entering the intersection 32 coming from the east. The visual and motion sensors 12, 16 of the first vehicle 14 will easily detect the presence of the emergency vehicle 34. The first scene point cloud created by the first computer processor 24 will include the emergency vehicle 34 and the onboard systems of the first vehicle 14 can react appropriately. However, a large tanker truck 36 that is passing through the intersection 32 occludes the visual sensors 18 of the second vehicle 20. The second scene point cloud created by the second computer processor 26 will not include the emergency vehicle 34. The second vehicle 20 will not be aware of the presence of the emergency vehicle 34, and thus may not take appropriate action based on the presence of the emergency vehicle 34. When the first scene point cloud and the second scene point cloud are merged by the third computer processor 28, the resulting stitched point cloud will include features that would otherwise not have been visible to both of the first and second vehicles 14, 20, such as the presence of the emergency vehicle 34. When the stitched point cloud is sent back to the first and second vehicles 14, 20, each of the first and second vehicles 14, 20 will have a better 3D volumetric representation of their surroundings.

In an exemplary embodiment, the first computer processor 24 is further adapted to generate a first raw point cloud using the first visual images and to generate a first roughly transformed point cloud by using the first motion data to transform the first raw point cloud. The first raw point cloud is created in a coordinate system based on the first visual sensors 12, such as a LIDAR coordinate system. The first computer processor 24 uses positional and orientation data of the first vehicle 14 collected by the first plurality of motion sensors 16 to transform the first raw point cloud to a world coordinate system. The first roughly transformed point cloud is based on the world coordinate system. Similarly, the second computer processor 26 is further adapted to generate a second raw point cloud using the second visual images and to generate a second roughly transformed point cloud based on the world coordinate system by using the second motion data to transform the second raw point cloud.

In another exemplary embodiment, the first computer processor 24 is further adapted to generate the first scene point cloud by using a high-definition map and applying a normal distribution transformation algorithm to the first roughly transformed point cloud, and the second computer processor 26 is further adapted to generate the second scene point cloud by using a high-definition map and applying a normal distribution transformation algorithm to the second roughly transformed point cloud. Each of the first and second computer processors 24, 26 have an HD map of the vicinity within which the first and second vehicles 14, 20 are traveling. The HD map may be acquired by downloading in real time from a cloud-based source via a WLAN, 4G or 5G network, or may be stored within memory of the first and second computer processors 24, 26.

The first computer processor 24 uses the HD map to align the first roughly transformed point cloud to create the first scene point cloud, which is more accurate than the first roughly transformed point cloud, and the second computer processor 26 uses the HD map to align the second roughly transformed point cloud with data from the HD map to create the second scene point cloud, which is more accurate than the second roughly transformed point cloud. Additionally, the HD map is aligned to the world coordinate system, thus, after applying the normal distribution transformation algorithm to the first and second scene point clouds in light of data from the HD map, the first and second scene point clouds will be aligned with one another.

In one exemplary embodiment, the first computer processor 24 is further adapted to remove dynamic objects 38 from the first roughly transformed point cloud prior to applying the normal distribution transformation algorithm, and the second computer processor 26 is further adapted to remove dynamic objects 38 from the second roughly transformed point cloud prior to applying the normal distribution transformation algorithm. Dynamic objects 38 in the first and second roughly transformed point clouds become noise when applying the normal distribution transformation algorithm. Thus, when the normal distribution transformation algorithm is applied only to the static objects 40 in the first and second roughly transformed point clouds, the resulting transformation matrix is more accurate.

In still another exemplary embodiment, the first computer processor 24 is further adapted to re-use a resulting first transformation matrix by inserting the resulting first transformation matrix back into the normal distribution transformation algorithm to improve accuracy of the first scene point cloud, and the second computer processor 26 is further adapted to re-use a resulting second transformation matrix by inserting the resulting second transformation matrix back into the normal distribution transformation algorithm to improve accuracy of the second scene point cloud. By re-using a first and second transformation matrix that provides results that satisfy a scoring threshold, the normal distribution transformation algorithm is applied again using the first and second resulting transformation matrices as a base-line. This will result in less iterations of the normal distribution transformation matrix and more accurate final first and second scene point clouds. After the normal distribution transformation algorithm has been applied, the dynamic objects are replaced within the first and second scene point clouds prior to sending the first and second scene point clouds to the third computer processor 28.

Finally, in another exemplary embodiment, the first and second computer processors 24, 26 are adapted to remove static data from the first and second scene point clouds. This may be done to reduce the file size of the first and second point clouds that are sent wirelessly to the third computer processor 28. The third computer processor 28, like the first and second computer processors 24, 26, has access to the HD map, and therefore can re-insert the static elements to the first and second point clouds after the first and second point clouds have been sent to the third computer processor 28.

In an alternate exemplary embodiment of the system 10, the first computer processor 24 is further adapted to generate a first raw point cloud using the first visual images and to generate the first scene point cloud by using the first motion data to transform the first raw point cloud, and the second computer processor 26 is adapted to generate a second raw point cloud using the second visual images and to generate the second scene point cloud by using the second motion data to transform the second raw point cloud. The first raw point cloud and the second raw point cloud are created in a coordinate system based on the first and second visual sensors 12, 18, such as a LIDAR coordinate system. The first computer processor 24 uses positional and orientation data of the first vehicle 14 collected by the first plurality of motion sensors 16 and the second computer processor 26 uses positional and orientation data of the second vehicle 20 collected by the second plurality of motion sensors 22 to transform the first raw point cloud and the second raw point cloud to the world coordinate system. The first and second scene point clouds are based on the world coordinate system.

In exemplary embodiment, the first computer processor 14 is further adapted to compress the first scene point cloud before the first scene point cloud is sent to the third computer processor 28, and the third computer processor 28 is adapted to de-compress the first scene point cloud after the first scene point cloud is sent to the third computer processor 28. Similarly, the second computer processor 26 is further adapted to compress the second scene point cloud before the second scene point cloud is sent to the third computer processor 28, and the third computer processor 28 is adapted to de-compress the second scene cloud after the second scene cloud is sent to the third computer processor 28. The first and second scene point clouds are compressed to reduce the file size that is being sent wirelessly from the first and second computer processors 24, 26 to the third computer processor 28. In one exemplary embodiment, the first and second scene clouds are compressed/de-compressed by an Octree-based point cloud compression method.

In another exemplary embodiment, the third computer processor 28 is further adapted to identify an overlap region between the first scene point cloud and the second scene point cloud by applying an overlap searching algorithm to the first scene point cloud and the second scene point cloud after the first scene point cloud and the second scene point cloud are de-compressed. The first and second scene point clouds include different data due to the different field of vision provided by the first and second visual sensors 12, 18 within the first and second vehicles 14, 20. The overlap searching algorithm identifies data points that appear in both the first and second scene point clouds to identify a region of overlap between the first and second scene point clouds.

The third computer processor 28 is further adapted to apply an iterative closest point-based point cloud alignment algorithm to the overlap region between the first scene point cloud and the second scene point cloud after the overlap region between the first scene point cloud and the second scene point cloud has been identified. The iterative closest point-based point cloud alignment algorithm aligns the first and second scene point clouds based on the over overlapping or common data points to orient the first and second scene point clouds to a common coordinate system.

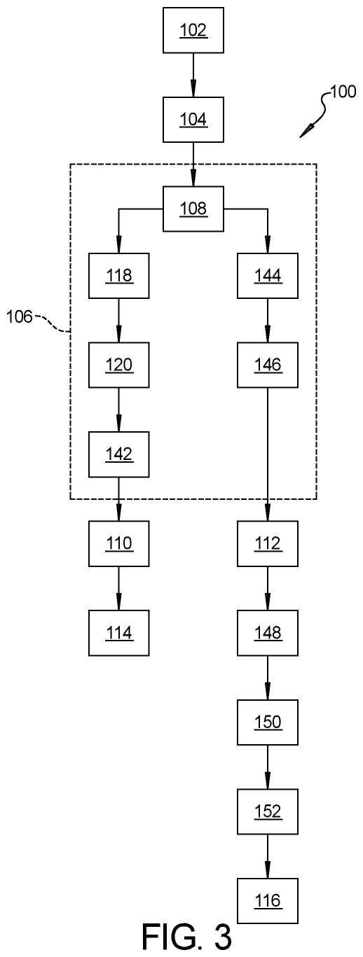

Referring to FIG. 3, a method 100 of creating a 3D volumetric scene using the system 10 described above includes, starting at block 102, obtaining first visual images from the first visual sensor 12 onboard the first vehicle 14 and obtaining second visual images from the second visual sensor 18 onboard the second vehicle 20, and, moving to block 104, obtaining first motion data from the first plurality of motion sensors 16 onboard the first vehicle 14 and obtaining second motion data from the second plurality of motion sensors 22 onboard the second vehicle 20. Moving to block 106, the method 100 includes generating, via the first computer processor 24 onboard the first vehicle 14, a first scene point cloud, using the first visual images and the first motion data, and generating, via the second computer processor 26 onboard the second vehicle 20, a second scene point cloud, using the second visual images and the second motion data. Moving to block 108, the first computer processor 24 generates the first raw point cloud using the first visual images and the second computer processor 26 generates the second raw point cloud using the second visual images.

Moving to blocks 110 and 112, the method 100 includes sending the first scene point cloud and the second scene point cloud to the third computer processor 28 located within an edge/cloud infrastructure 30, and moving to blocks 114 and 116, the first scene point cloud and the second scene point cloud are merged, creating a stitched point cloud.

Beginning at block 108, in one exemplary embodiment of the method 100, moving to block 118, the generating, at block 106, via the first computer processor 24 onboard the first vehicle 14, a first scene point cloud, using the first visual images and the first motion data, and generating, via the second computer processor 26 onboard the second vehicle 20, a second scene point cloud, using the second visual images and the second motion data includes generating, via the first computer processor 24, the first roughly transformed point cloud by using the first motion data to transform the first raw point cloud and generating, via the second computer processor 26, the second roughly transformed point cloud by using the second motion data to transform the second raw point cloud. This transformation aligns the first and second roughly transformed point clouds to the world coordinate system.

Moving to block 120, the method further includes generating, via the first computer processor 24, the first scene point cloud by using a high-definition map and applying the normal distribution transformation algorithm to the first roughly transformed point cloud, and generating, via the second computer processor 26, the second scene point cloud by using a high-definition map and applying the normal distribution transformation algorithm to the second roughly transformed point cloud. In an exemplary embodiment, before applying the normal distribution transformation algorithm dynamic objects 38 are removed from the first and second roughly transformed point clouds prior to applying the normal distribution transformation algorithm. Part of the normal distribution transformation algorithm includes re-using a resulting first transformation matrix obtained by applying the normal distribution transformation algorithm by inserting the resulting first transformation matrix back into the normal distribution transformation algorithm to improve accuracy of the first scene point cloud, and re-using a resulting second transformation matrix obtained by applying the normal distribution transformation algorithm by inserting the resulting second transformation matrix back into the normal distribution transformation algorithm to improve accuracy of the second scene point cloud.

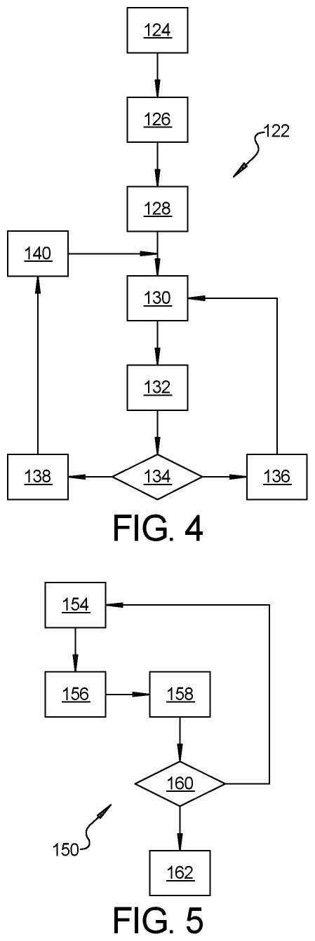

Referring to FIG. 4, a flow chart 122 illustrating the application of the normal distribution transformation algorithm includes, starting at block 124, voxelization of the first and second roughly transformed scene point clouds, and moving to block 126, performing probability distribution modeling for each voxel of the first and second roughly transformed scene point clouds using the formula:

$$p ( x ) \sim exp ( - \frac{{( x - q )}^{t} {\sum }^{- 1} ( x - q )}{2} ) .$$

Moving to block 128, as mentioned above, dynamic objects 38 are removed from the first and second roughly transformed point clouds prior to applying the normal distribution transformation algorithm. Dynamic objects 38 in the first and second roughly transformed point clouds become noise when applying the normal distribution transformation algorithm. Thus, when the normal distribution transformation algorithm is applied only to the static objects 40 in the first and second roughly transformed point clouds, the resulting transformation matrix is more accurate.

Moving to block 130, the normal distribution transformation algorithm is applied. Moving to block 132, the resulting first transformation matrix from the application of the normal distribution transformation algorithm to the first roughly transformed point cloud is scored by calculating the probability the each source point resides in a corresponding voxel by using the formula:

$$score ( p ) = {\sum }_{i} exp ( \frac{- {( {x}_{j}^{j} - {q}_{i} )}^{t} {\sum }_{i}^{- 1} ( {x}_{i}^{j} - {q}_{i} )}{2} ) .$$

At block 134, the score of each of the first and second resulting transformation matrices are compared to a threshold value. If the score is worse than the threshold, then, moving to block 136, the process is repeated iteratively, until the resulting transformation matrix scores better than the threshold. When, at block 134, the score is better than the threshold, then, moving to block 138, a favorably scored resulting first transformation matrix obtained by applying the normal distribution transformation algorithm is re-inserted into the normal distribution transformation algorithm to improve accuracy of the first scene point cloud. Likewise, when, at block 134, the score is better than the threshold, then, moving to block 138, a favorably scored resulting second transformation matrix obtained by applying the normal distribution transformation algorithm is re-inserted into the normal distribution transformation algorithm to improve accuracy of the second scene point cloud.

Moving to block 140, by re-using a first and second transformation matrix that provides results that satisfy a scoring threshold, the normal distribution transformation algorithm is applied again using the first and second resulting transformation matrices as a base-line. This will result in less iterations of the normal distribution transformation matrix and more accurate final first and second scene point clouds. After the normal distribution transformation algorithm has been applied, the dynamic objects are replaced within the first and second scene point clouds prior to sending the first and second scene point clouds to the third computer processor.

Finally, in another exemplary embodiment, moving to block 142, the first and second computer processors 24, 26 are adapted to move static data from the first and second scene point clouds. This may be done to reduce the file size of the first and second point clouds that are sent wirelessly to the third computer processor 28. The third computer processor 28, like the first and second computer processors 24, 26, has access to the HD map, and therefore can re-insert the static elements to the first and second point clouds after the first and second point clouds have been sent to the third computer processor 28.

Beginning again at block 108, in another exemplary embodiment of the method 100, moving to block 144, the generating, at block 106, via the first computer processor 24 onboard the first vehicle 14, a first scene point cloud, using the first visual images and the first motion data, and generating, via the second computer processor 26 onboard the second vehicle 20, a second scene point cloud, using the second visual images and the second motion data includes generating, via the first computer processor 24, the first scene point cloud by using the first motion data to transform the first raw point cloud and generating, via the second computer processor 26, the second scene point cloud by using the second motion data to transform the second raw point cloud. This transformation aligns the first and second scene point clouds to the world coordinate system.

Moving to block 146, prior to sending, at block 112, the first scene point cloud and the second scene point cloud to the third computer processor 28, the first computer processor compresses the first scene point cloud, and the second computer processor compresses the second scene point cloud. Moving to block 148, after being received by the third computer processor 28, the third computer processor 28 de-compresses the first and second scene point clouds. In an exemplary embodiment, compressing/de-compressing the first scene point cloud and the second scene point cloud is by an Octree-based point cloud compression method.

Moving to block 150, the method includes identifying an overlap region between the first scene point cloud and the second scene point cloud by applying, via the third computer processor 28, an overlap searching algorithm to the first scene point cloud and the second scene point cloud after de-compressing the first scene point cloud and the second scene point cloud. The overlap searching algorithm identifies data points that appear in both the first and second scene point clouds to identify a region of overlap between the first and second scene point clouds.

Moving to block 152, the method includes applying, via the third computer processor 28, an iterative closest point-based point cloud alignment algorithm to the overlap region between the first scene point cloud and the second scene point cloud after identifying the overlap region between the first scene point cloud and the second scene point cloud. The iterative closest point-based point cloud alignment algorithm aligns the first and second scene point clouds based on the over overlapping or common data points to orient the first and second scene point clouds to a common coordinate system. It should be understood that the system 10 and the method 100 described herein is applicable to collect data from any number of vehicles. Any vehicle that is equipped to do so, can be uploading data to the third computer processor 28.

Referring to FIG. 5, a flow chart illustrating the application of the iterative closest point-based point cloud alignment algorithm is shown. Beginning at block 154, the first and second scene point clouds are obtained and correspondence matching between a target and source scene point cloud begins. Moving to block 156, a transformation matrix is estimated, and at block 158, the transformation is applied. Moving to block 160, a transformation error is compared to an error threshold using the formula:

$${\sum }_{i} dist ( {p}_{i , source} , {q}_{i , target} ) > ε$$

If the error is greater than the threshold, then, moving back to block 152, the process is repeated iteratively until a transformation matrix having an error that does not exceed the threshold is attained, meaning the first and second point clouds are aligned on a common coordinate system, at block 162.

As stated above, the method described herein is applicable to more than just a first and second vehicle 14, 20. When scene point clouds are obtained for a number of applicable vehicles, one of the scene point clouds is designated as the source point cloud and all the other scene point clouds are designated as target point clouds. The iterative closest point-based point cloud algorithm aligns each target scene point cloud to the source scene point cloud. When complete, all of the received scene point clouds are aligned to the coordinate system of the source scene point cloud.

A method and system of the present disclosure offers the advantage of providing a more accurate 3D volumetric point cloud of a vehicle's environment to allow the vehicle to make more accurate decisions regarding navigation and safety.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of creating a 3D volumetric scene, comprising:
obtaining first visual images from a first visual sensor onboard a first vehicle;
obtaining first motion data from a first plurality of motion sensors onboard the first vehicle;
generating, via a first computer processor onboard the first vehicle, a first scene point cloud, using the first visual images and the first motion data;
obtaining second visual images from a second visual sensor onboard a second vehicle;
obtaining second motion data from a second plurality of motion sensors onboard the second vehicle;
generating, via a second computer processor onboard the second vehicle, a second scene point cloud, using the second visual images and the second motion data;
sending the first scene point cloud and the second scene point cloud to a third computer processor located within an edge/cloud infrastructure; and
merging, via the third computer processor, the first scene point cloud and the second scene point cloud and creating a stitched point cloud.

2. The method of claim 1, further including:
generating, via the first computer processor, a first raw point cloud using the first visual images;
generating, via the first computer processor, a first roughly transformed point cloud by using the first motion data to transform the first raw point cloud;
generating, via the second computer processor, a second raw point cloud using the second visual images; and
generating, via the second computer processor, a second roughly transformed point cloud by using the second motion data to transform the second raw point cloud.

3. The method of claim 2, further including:
generating, via the first computer processor, the first scene point cloud by using a high-definition map and applying a normal distribution transformation algorithm to the first roughly transformed point cloud; and
generating, via the second computer processor, the second scene point cloud by using a high-definition map and applying a normal distribution transformation algorithm to the second roughly transformed point cloud.

4. The method of claim 3, wherein:
the generating, via the first computer processor, the first scene point cloud by using a high-definition map and applying the normal distribution transformation algorithm to the first roughly transformed point cloud further includes removing dynamic objects from the first roughly transformed point cloud prior to applying the normal distribution transformation algorithm; and
the generating, via the second computer processor, the second scene point cloud by using a high-definition map and applying the normal distribution transformation algorithm to the second roughly transformed point cloud further includes removing dynamic objects from the second roughly transformed point cloud prior to applying the normal distribution transformation algorithm.

5. The method of claim 4, wherein:
the generating, via the first computer processor, the first scene point cloud by using a high-definition map and applying the normal distribution transformation algorithm to the first roughly transformed point cloud further includes re-using a resulting first transformation matrix by inserting the resulting first transformation matrix back into the normal distribution transformation algorithm to improve accuracy of the first scene point cloud; and
the generating, via the second computer processor, the second scene point cloud by using a high-definition map and applying the normal distribution transformation algorithm to the second roughly transformed point cloud further includes re-using a resulting second transformation matrix by inserting the resulting second transformation matrix back into the normal distribution transformation algorithm to improve accuracy of the second scene point cloud.

6. The method of claim 1, further including:
generating, via the first computer processor, a first raw point cloud using the first visual images;
generating, via the first computer processor, the first scene point cloud by using the first motion data to transform the first raw point cloud;
generating, via the second computer processor, a second raw point cloud using the second visual images; and
generating, via the second computer processor, the second scene point cloud by using the second motion data to transform the second raw point cloud.

7. The method of claim 6, wherein sending the first scene point cloud and the second scene point cloud to a third computer processor further includes:
compressing, via the first computer processor, the first scene point cloud prior to sending the first scene point cloud to the third computer processor, and de-compressing, via the third computer processor, the first scene point cloud after sending the first scene point cloud to the third computer processor; and
compressing, via the second computer processor, the second scene point cloud prior to sending the second scene point cloud to the third computer processor, and de-compressing, via the third computer processor, the second scene point cloud after sending the second scene point cloud to the third computer processor.

8. The method of claim 7, wherein compressing/de-compressing the first scene point cloud and the second scene point cloud is by an Octree-based point cloud compression method.

9. The method of claim 7, further including identifying an overlap region between the first scene point cloud and the second scene point cloud by applying, via the third computer processor, an overlap searching algorithm to the first scene point cloud and the second scene point cloud after de-compressing the first scene point cloud and the second scene point cloud.

10. The method of claim 9, further including applying, via the third computer processor, an iterative closest point-based point cloud alignment algorithm to the overlap region between the first scene point cloud and the second scene point cloud after identifying the overlap region between the first scene point cloud and the second scene point cloud.

11. A system for creating a 3D volumetric scene, comprising:
a first visual sensor positioned onboard a first vehicle and adapted to obtain first visual images;
a first plurality of motion sensors positioned onboard the first vehicle and adapted to obtain first motion data;
a first computer processor positioned onboard the first vehicle and adapted to generate a first scene point cloud, using the first visual images and the first motion data;
a second visual sensor positioned onboard a second vehicle and adapted to obtain second visual images;
a second plurality of motion sensors positioned onboard the second vehicle and adapted to obtain second motion data; and
a second computer processor positioned onboard the second vehicle and adapted to generate a second scene point cloud, using the second visual images and the second motion data;
the first computer processor further adapted to send the first scene point cloud to a third computer processor and the second computer processor further adapted to send the second scene point cloud to the third computer processor; and
the third computer processor located within an edge/cloud infrastructure and adapted to merge the first scene point cloud and the second scene point cloud and create a stitched point cloud.

12. The system of claim 11, wherein the first computer processor is further adapted to generate a first raw point cloud using the first visual images and to generate a first roughly transformed point cloud by using the first motion data to transform the first raw point cloud, and the second computer processor is further adapted to generate a second raw point cloud using the second visual images and to generate a second roughly transformed point cloud by using the second motion data to transform the second raw point cloud.

13. The system of claim 12, wherein the first computer processor is further adapted to generate the first scene point cloud by using a high-definition map and applying a normal distribution transformation algorithm to the first roughly transformed point cloud, and the second computer processor is further adapted to generate the second scene point cloud by using a high-definition map and applying a normal distribution transformation algorithm to the second roughly transformed point cloud.

14. The system of claim 13, wherein the first computer processor is further adapted to remove dynamic objects from the first roughly transformed point cloud prior to applying the normal distribution transformation algorithm, and the second computer processor is further adapted to remove dynamic objects from the second roughly transformed point cloud prior to applying the normal distribution transformation algorithm.

15. The system of claim 14, wherein the first computer processor is further adapted to re-use a resulting first transformation matrix by inserting the resulting first transformation matrix back into the normal distribution transformation algorithm to improve accuracy of the first scene point cloud, and the second computer processor is further adapted to re-use a resulting second transformation matrix by inserting the resulting second transformation matrix back into the normal distribution transformation algorithm to improve accuracy of the second scene point cloud.

16. The system of claim 11, wherein the first computer processor is further adapted to generate a first raw point cloud using the first visual images and to generate the first scene point cloud by using the first motion data to transform the first raw point cloud, and the second computer processor is adapted to generate a second raw point cloud using the second visual images and to generate the second scene point cloud by using the second motion data to transform the second raw point cloud.

17. The system of claim 16, wherein the first computer processor is further adapted to compress the first scene point cloud before the first scene point cloud is sent to the third computer processor, the third computer processor is adapted to de-compress the first scene point cloud after the first scene point cloud is sent to the third computer processor, the second computer processor is further adapted to compress the second scene point cloud before the second scene point cloud is sent to the third computer processor, and the third computer processor is adapted to de-compress the second scene cloud after the second scene cloud is sent to the third computer processor.

18. The system of claim 17, wherein the first scene point cloud and the second scene point cloud are each compressed/de-compressed by an Octree-based point cloud compression method.

19. The system of claim 17, wherein the third computer processor is further adapted to identify an overlap region between the first scene point cloud and the second scene point cloud by applying an overlap searching algorithm to the first scene point cloud and the second scene point cloud after the first scene point cloud and the second scene point cloud are de-compressed.

20. The system of claim 19, wherein the third computer processor is further adapted to apply an iterative closest point-based point cloud alignment algorithm to the overlap region between the first scene point cloud and the second scene point cloud after the overlap region between the first scene point cloud and the second scene point cloud has been identified.
